(19) United States
(12) Patent Application Publication
(10) Pub. No.: US 2008/0163318 A1
(43) Pub. Date: Jul. 3, 2008

(54) Mobile multimedia content sharing application system

(75) Inventors: Jian Feng Chen, Beijing (CN); Kai Chen, Beijing (CN); Cai Xia Chi, Beijing (CN); Ruibing Hao, Beijing (CN); Da Wei Wang, Beijing (CN); Dong Wang, Beijing (CN)

Correspondence Address: HARNESS, DICKEY & PIERCE, P.L.C., P.O. BOX 8910, RESTON, VA, 20195, US

(73) Assignee: LUCENT TECHNOLOGIES INC

(21) Appl. No.: 11/802,660

(22) Filed: May 24, 2007

(30) Foreign Application Priority Data
Dec. 29, 2006 (CN) 200610130902.2

(51) Int. Cl. H04N 7/173

(52) U.S. Cl. 725/109

(57) ABSTRACT

A user subscribes to desired information in an RSS gateway, and the RSS gateway aggregates the subscription requests from users before subscribing to requested multimedia content. The RSS gateway aggregates subscription requests from a plurality of users and subscribes to the requested RSS feeds on behalf of the users. The RSS gateway also receives RSS feeds from content servers and RSS web-sites and sends the received RSS feeds to subscribing users using SIP.

### PRIORITY STATEMENT

This non-provisional patent application claims priority under 35 U.S.C. § 119 to Chinese patent application No. 200610130902.2 filed on Dec. 29, 2006 in the Chinese Patent Office, the entire contents of which are incorporated herein by reference.

### BACKGROUND OF THE INVENTION

A 3rd Generation Partnership Project Internet Protocol Multimedia Subsystem (3GPP-IMS) is a converged telecommunications architecture merging cellular (or mobile) and Internet technologies to deliver multimedia content, such as, voice, video and/or data on a single network.

A conventional 3GPP-IMS architecture employs Voice- and Video-over-IP technology based on a 3GPP profile of the session initiation protocol (SIP). A conventional IMS architecture or core network may include a plurality of SIP application servers (e.g., including a WebLogic SIP Server). Conventionally, SIP application servers offer a programming language and framework for creating new services.

The conventional IMS network also includes a call session control function (CSCF) for managing call establishment, call management and/or call release and through which SIP signaling traverses. The CSCF inspects each SIP message and determines if the signaling messages should traverse one or more SIP application servers before reaching its final destination. The CSCF also interacts with a Home Subscriber Service (HSS).

The HSS provides a central repository of user-related information. For example, the HSS may store a user profile for each user present in the IMS system. The HSS may also store a mapping table associating SIP IDs with each network element (e.g., users, CSCF, SIP application server, etc.) in the IMS network. A SIP ID is a unique number associated with a particular network element in the IMS. For example, SIP ID may be used much like a telephone number for VOIP between SIP phones.

Users may access conventional IMS systems using IMS client devices. Examples of IMS client devices are personal computers, personal digital assistants (PDA), mobile phones, smart phones, etc. equipped with software for performing desired IMS operations. An IMS client is an example of software for performing desired IMS operations. For purposes of simplicity, the IMS client and IMS client device will be collectively referred to herein as an IMS client device.

Currently, high resolution cameras and multimedia support are becoming common features for IMS client devices such as mobile phones and smart phones. However sharing of multimedia content (e.g., photos, video clips, audio clips, data, etc.) stored in the IMS client device with friends, colleagues and other family members is relatively difficult. In addition, web-sites and personal web logs (or blogs) with content described in RSS feeds are becoming more effective ways to share this type of content on the Internet.

Currently, the most common way of sharing multimedia content among mobile users is through multimedia messaging services (MMS), and the most common way of sharing multimedia content between Internet users and mobile users is via email. However, a growing number of Internet blog hosting sites have been enhanced with mobile blogging support, enabling a mobile user to publish multimedia content directly to his blog from his mobile phone using, for example, MMS or email.

However, sharing multimedia content through MMS or email has several drawbacks. First, each of MMS and email share information in a 1 to 1 manner. That is, if a mobile user wants to share content with N other mobile users, N copies of the same content need to be transmitted. This results in unnecessarily wasted bandwidth because the sending mobile user must send the same message N times, and the receiver has no control over the content delivery. In addition, MMS has a content transfer size constraint of less than 50 k of information.

Moreover, when mobile blogging through MMS or email, a mobile subscriber must manually input his blog account name and password inside the MMS or email body, which is very cumbersome for mobile users to use due to the size and shape of mobile phone keyboards. Accessing published content from cellular phones is also difficult because the blogger must use the web browser embedded in the mobile phone to pull the entire content of a blog from the hosting web-site, which may be inefficient and relatively costly. In this example, even when content has not changed, mobile users desiring to read the blog may pull the entire content of the blog, even if only a single item or nothing on the blog has changed. In addition, when new content is posted, there is no efficient way to notify interested parties.

### SUMMARY OF THE INVENTION

Example embodiments of the present invention relate to application systems for an IMS, which may enable multimedia content sharing in a converged IMS and Internet infrastructure. An application system, according to at least one example embodiment of the present invention, provides a more generic manner for on-demand multimedia content (e.g., text, picture, audio, video, etc.) sharing in a converged 3GPP-IMS environment and the Internet.

Example embodiments of the present invention may enable users to share multimedia content across converged networks using intelligent multimedia content indexing, searching and filtering such that users may subscribe and/or customize preferred or desired content.

At least some example embodiments utilize best-in-breed push technology for each network having integrated multiple notification technologies to distribute RSS content such as SIP, WAP Push or JavaScript Pushlet technology. Example embodiments provide a more efficient multimedia content description by using media RSS digest such that users may receive, for example, thumbnails for photos, fragments of entire audio clips before receiving the entire photo or audio clip in order to decide downloading of the entire file is warranted, etc.

In at least one example embodiment, a user subscribes to desired information in both an APB server and an RSS gateway, and the RSS gateway aggregates the subscription requests from users before subscribing to requested multimedia content. For example, the RSS gateway may aggregate the subscription requests from a plurality of users and then subscribe to the requested RSS feeds on behalf of the users. The RSS gateway also receives RSS feeds via HTTP from content servers and RSS web-sites and sends the received RSS feeds to subscribing users using, for example, SIP, WAP Push, etc. In this example embodiment, subscribing users may only receive notifications regarding desired content.

### BRIEF DESCRIPTION OF THE DRAWINGS

The present invention will become more fully understood from the detailed description given herein below and the accompanying drawings, wherein like elements are represented by like reference numerals, which are given by a way of illustration only and thus are not limiting of the present invention and wherein:

FIG. 1 illustrates a mobile multimedia content sharing application system, according to an example embodiment;

FIG. 2 is a block diagram illustrating the architecture of the multimedia content sharing application system shown in FIG. 1 with the core IMS network elements omitted;

FIG. 3 illustrates a message flow diagram for RSS subscription management, according to an example embodiment;

FIG. 4 illustrates a message flow diagram for a subscription message flow, according to an example embodiment; and

FIG. 5 illustrates a message flow diagram showing a message flow between an APB server, an RSS gateway and an RSS-enabled content server, according to an example embodiment.

### DETAILED DESCRIPTION OF EXAMPLE EMBODIMENTS

Example embodiments of the present invention are directed to an application system/service for a converged 3GPP-IMS network, which implements more user-friendly and/or more cost effective push-mode multimedia content sharing using a combination of mobile blogging technology and IMS SIP event subscription/notification scheme. At least some example embodiments of the present invention facilitate multimedia content sharing among mobile users (e.g., between mobile IMS client devices) and between mobile users and Internet (or stationary) users. Multimedia content may be, for example, text, pictures, video, audio clips and documents such as, word, PPT files, etc.

According to example embodiments, multimedia content may be provided using Really Simple Syndication (RSS). Really Simple Syndication (RSS) is a text format used in information fields such as headlines and summary paragraphs on RSS web-sites to facilitate distribution of updated content to, for example, subscribing IMS client devices. In one example, when new content is added to an RSS web-site, an IMS client device may automatically receive an indication that new content has been added. The RSS web-site may push, or send an unsolicited message, an indication of the newly added content. The unsolicited message may include, for example, a thumbnail photo, a portion of an audio clip, etc. Using the IMS client device, a user may browse updated content without actually visiting the web-site itself.

For example, if a web-site contains RSS-distributed news, when a new article is posted to the site, the headline and/or a brief summary of the newly posted news article may be sent to the IMS client device. The user may then view the received summary of the actual article in order to determine whether to visit the website and access the entire article.

Similar to that as discussed above, users may access IMS systems, according to example embodiments, using IMS client devices. Examples of IMS client devices are personal computers, personal digital assistants (PDA), mobile phones, smart phones, etc. equipped with software for performing desired IMS operations. An IMS client is an example of software for performing desired IMS operations. According to example embodiments, the IMS client may be an enhanced APB client, which is well-known in the art. As noted above, for purposes of simplicity, the IMS client and IMS client device will be collectively referred to herein as an IMS client device. The term IMS client device may refer to mobile IMS client devices such as portable computers (laptops), personal digital assistants (PDA), mobile phones, smart phones, etc., as well as less mobile IMS client devices such as stationary or desktop personal computers. Moreover, example embodiments of the present invention may be equally applicable to all IMS client devices described herein; however, the example embodiments discussed herein refer to mobile IMS client devices.

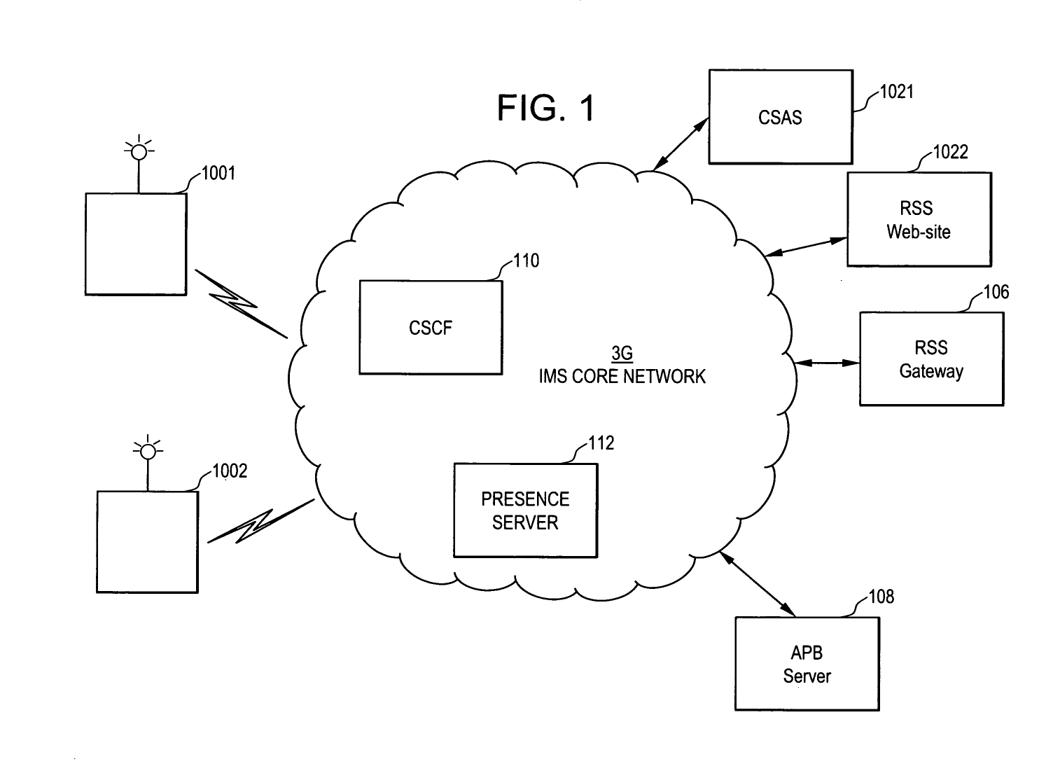

FIG. 1 illustrates a mobile multimedia content sharing application system, according to an example embodiment. As discussed above, call session control functions (CSCFs) 110, a home subscriber server (HSS) (not shown) and a presence server 112 are conventional IMS core network elements, and well-known in the art. Therefore, a detailed discussion of these elements will be omitted for the sake of brevity. In addition to the core IMS network elements, FIG. 1 also illustrates IMS client devices 1001 and 1002, an active phone book (APB) server 108, an RSS gateway 106 and a plurality of content servers 1021 and 1022. Each of the content servers 1021 and 1022 may be a content sharing application server (CSAS), an RSS-enabled web-server hosting an RSS-enabled web-site (hereinafter referred to as an RSS web-site) or a combination thereof. Although only two content servers are illustrated in FIG. 1, IMS systems, according to example embodiments, may include and support any number of content servers. Similarly, although only two IMS client devices 1001 and 1002 are illustrated in FIG. 1, IMS systems, according to example embodiments, may include and support any number of IMS client devices 1001 and 1002. That is, for example, any number of IMS client devices 1001 and 1002 may access the IMS system simultaneously.

For the sake of clarity, the IMS system described herein assumes the APB server 108, the RSS gateway 106 and the core 3G IMS network elements are managed by the same service provider (SP), while content servers 1021 and 1022 are operated by one or more 3rd party SP. However, the same service provider may control or run the content servers 1021 and 1022 as well. Moreover, for the sake of clarity, example embodiments will be described with regard to content server 1021 being a CSAS, and content server 1022 being an RSS web-site. Example embodiments will also be described with respect to IMS client device 1001. Although, in some cases, the IMS client devices 1001 and 1002 will be described to more clearly illustrate example embodiments of the present invention. A publishing IMS client device may be a provider of multimedia content, and a subscribing IMS client device may be an IMS client device requesting multimedia content published by other IMS client devices, for example, IMS client device 1001. It will be understood, however, that each IMS client device may publish and/or subscribe to multimedia content.

According to at least some example embodiments, the IMS client devices 1001 and 1002 may communicate with the IMS core network via one or more base stations or mobile station controllers (not shown) in a Mobile communications network, such as a UMTS network. However, for the purposes of clarity, these elements have been omitted for the sake of clarity. Moreover, the content servers 1021 and 1022, the RSS gateway 106 and/or the APB server 108 may communicate with one another and/or the IMS core network via one or more circuit and/or packet switched networks (not shown). For example, the content servers 1021 and 1022, the RSS gateway 106 and/or the APB server 108 may communicate with one another and/or the IMS core network via the Internet (not shown).

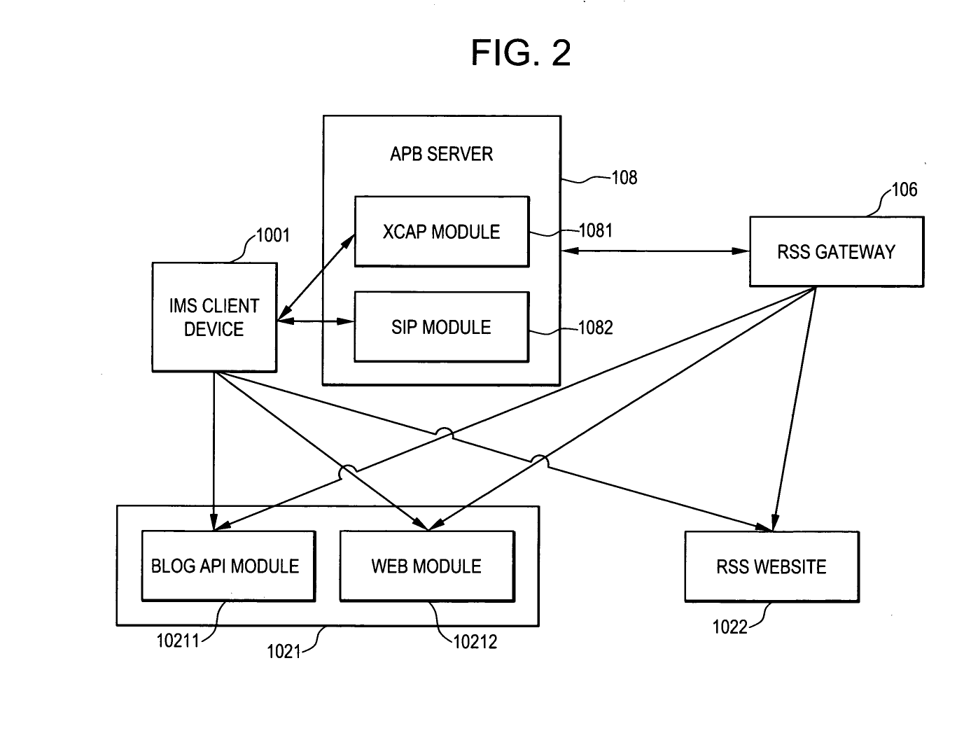

FIG. 2 is a block diagram illustrating the architecture of the multimedia content sharing application system shown in FIG. 1 with the core IMS network elements omitted. In FIG. 2, the IMS client device represents either of IMS client 1001 and 1002. However, FIG. 2 will be discussed with regard to IMS client device 1001 for the sake of clarity.

Referring to FIG. 2, IMS client device 1001 may support the functions required by an SIP user agent and may also support the presence feature, both of which are well-known in the art. For example, IMS client device 1001 may support SUBSCRIBE/NOTIFY methods of the SIP protocol, which are defined for SIP-specific event notification. Example SUBSCRIBE/NOTIFY methods of the SIP protocol are described in Niemi, Ed, “Session Initiation Protocol (SIP) Extension for Event State Publication”, RFC 3903, October 2004, the entire contents of which are incorporated herein by reference.

The IMS client device 1001 may also utilize other well-known notification methods associated with an SIP user agent, such as INVITE, BYE, PUBLISH, etc. According to example embodiments, the IMS client device 1001 may subscribe to RSS channels (e.g., a group of RSS feeds) using SUBSCRIBE messages and receive RSS feeds via NOTIFY messages. Besides the SIP protocol, the IMS client device 1001 may also support Extensible Markup Language (XML) Configuration Access Protocol (XCAP), hyper-text transfer protocol (HTTP) and BLOG-API, each of which are well-known in the art. A brief discussion of each of these protocols will be discussed below for the sake of clarity. However, a further detailed discussion will be omitted for the sake of brevity.

BLOG-API is a programming interface allowing IMS client device 1001 to obtain, create and/or modify text and/or other attributes of web blog or other multimedia posts made at a content server. BLOG-API builds on the XML-RPC communication protocol, which is also well-known in the art. XML-RPC allows software running on separate operating systems, and in different environments, to make procedure calls over circuit-switched and/or packet-switched networks such as the Internet. XML-RPC also allows remote procedure calling using HTTP as the transport and XML for encoding.

IMS client device 1001 may support BLOG-API for publishing content to the CSAS 1021. For example, using BLOG-API, IMS client device 1001 may update a content sharing repository on the CSAS 1021. In updating the content sharing repository, IMS client device 1001 may publish a post (e.g., multimedia content) containing text, picture, video and/or audio by uploading the content from the IMS client device 1001 to CSAS 1021 through (e.g., directly through) BLOG-API module 10211 within the CSAS 1021. The BLOG-API module 10211 and the CSAS 1021 will be discussed in more detail below.

Still referring to FIG. 2, IMS client device 1001 may use the well-known HTTP to access resources stored at CSAS 1021. HTTP is also a basic transport protocol used by BLOG-API and XCAP protocols. Using HTTP, IMS client device 1001 may be capable of displaying web content (e.g., through a mobile web-browser) and/or receiving detailed information described by an item in the RSS feed. IMS client device 1001 may also use HTTP protocol to view shared content from a content sharing repository for a particular IMS client device at the CSAS 1021 or display web content (e.g., a web-site) hosted at CSAS 1021 or RSS web-site 1022.

Using XCAP, IMS client device 1001 may read, write and/or modify application configuration data, stored in XML format on a server. XCAP maps XML document sub-trees and element attributes to HTTP URIs, so that these components may be accessed directly using HTTP. XCAP may be used to exchange subscriber configuration between IMS client device 1001 and APB server 108. Subscriber configuration includes, for example, buddy list information regarding weblog content to which a particular IMS client device wants to subscribe.

In one example, IMS client device 1001 may receive content summary updates regarding available shared content published by other IMS client devices (e.g., IMS client device 1002) stored in the buddy list at the IMS client device 1001. A buddy list is a list of family, friends, colleagues, or any other users stored within an IMS client device, for example, a mobile phone. Buddy lists are well-known in the art, and thus, a detailed discussion will be omitted for the sake of brevity. The IMS client device 1001 may also access shared content on demand and/or publish or post (e.g., share) multimedia content to CSAS 1021. When IMS client device 1001 shares or publishes content, IMS client device 1001 may specify other users authorized to access the content.

The IMS client device 1001 may subscribe to multimedia content either directly, or via the APB server 108. The APB server 108 may manage buddy lists for IMS client device 1001, implement XML Document management (XDM) capabilities as described in IETF OMA-TS-XDM_CORE_V1_{—}0, and/or implement resource list server (RLS) capabilities, as described in 3GPP RFC 4662, the entire contents of both of which are incorporated herein by reference.

In at least one example embodiment, APB server 108 may be an implementation of a resource list server (RLS) as defined in 3GPP TS 24.141, the entire contents of which is incorporated by reference. Because the RLS is well-known in the art, only a brief discussion will be provided, but a detailed discussion will be omitted for the sake of brevity. In accordance with the capabilities of the RLS, the APB server 108 may accept subscriptions to resource lists from subscribing IMS client devices (e.g., users operating or using the above-discussed IMS client devices) and send notifications to update subscribing IMS client devices of the state of resources in a resource list.

Still referring to FIG. 2, as IMS client device 1001 may be in two-way communication with APB server 108. APB server 108 may include an XCAP module 1081 and an SIP module 1082. Each of the XCAP module 118 and the SIP module 128 may be modules as described in draft-ietf-simple-xcap-12 and 3GPP RFC 3261, respectively. The entire contents of each of these documents are incorporated herein by reference. For example, as discussed above, the XCAP module 1081 may allow IMS client device 1001 to read, write and/or modify application configuration data stored at the APB server 108. One type of application configuration data is an RSS channel list. The RSS channel list may include RSS channels to which the IMS client device 1001 has subscribed. As is known in the art, SIP protocol may be used as the transport mechanism or protocol for event notification. One or more RSS feeds associated with RSS channels in the RSS channel list may be transmitted in each event notification message (e.g., NOTIFY message).

The APB server 108 may also interact or interface with RSS gateway 106 on the behalf of IMS client device 1001 to retrieve content summary updates in the form of, for example, an RSS feed from a particular content server 1021 or 1022. An example of the two-way communication between the APB server 108 and the RSS gateway 106 will be discussed in more detail below.

RSS gateway 106 may be an SIP application server bridging the content servers 1021 and 1022 and the APB server 108 and/or IMS client device 1001. An SIP application server executes IMS applications and services by manipulating SIP signaling and interfacing with other systems. As discussed above, SIP application servers and their functions are well-known in the art, and defined in 3GPP TS 23.002, the entire contents of which is incorporated herein by reference. Briefly, an SIP application server may include HTTP capabilities to act as a content server for resources such as media files, VoiceXML application scripts, etc. In accordance with the capabilities of an SIP application server, the RSS gateway 106 may deliver content summaries in the form of RSS feeds to IMS client devices using SIP event notification.

In one example embodiment, the RSS gateway 106 may collect or aggregate RSS feeds from CSAS 1021, in response to SIP SUBSCRIBE messages from the APB server 108, and respond with notifications using SIP NOTIFY messages including one or more embedded RSS feeds. This message flow will be described in more detail below.

The RSS gateway 106 may also maintain a mapping table associating SIP IDs in the IMS network with serving content servers 1021 and 1022. As discussed above, an SIP ID is a unique identification number associated with a particular network element in an IMS system. This mapping relationship may be retrieved from the HSS (not shown). Methods in which the mapping relationship is retrieved from the HSS are well-known in the art, and therefore, a detailed discussion will be omitted for the sake of brevity. In one example embodiment, when IMS client device 1001 accesses the IMS system by subscribing to a content sharing service at, for example, CSAS 1021, a mapping for IMS client device 1001 may be created and saved in a user profile on the HSS. For example, when the RSS gateway 106 receives a subscription request from IMS client device 1001, the RSS gateway 106 may query and obtain mappings from the HSS.

In order to provide different subscribing IMS client devices with different current statuses of content, the RSS gateway 106 maintains a database storing the RSS feeds received from the content servers 1021 and 1022. As different subscribing IMS client devices request different RSS feeds, the RSS gateway 106 may re-organize the aggregate RSS feeds. When RSS gateway 106 receives RSS feeds from content servers, the RSS gateway 106 stores the RSS feed into the RSS feed database according to the date of receipt. The RSS feeds may then be re-constructed and sent to IMS clients in the body of one or more NOTIFY messages according to each IMS client device's subscription state and subscription policy.

The RSS gateway 106 may also maintain a feed item table, in which the content of the RSS feed may be cached. The columns of the feed item table may include title, link, description, guid, pubDate, source element and the ID of the permission list. Each of title, link, description and guid are well-known as described in the RSS 2.0 specification, the entire contents of which is incorporated herein by reference. The source element may include the RSS channel information. The RSS gateway 106 may maintain a subscription table in the database. The columns may include RSS channel, online subscribers and subscribe filters. This table may be stored in any conventional memory at the RSS gateway 106.

Still referring to FIG. 2, the RSS gateway 106 may also translate incoming RSS feeds from RSS-enabled content servers to a format suitable for transmission over a mobile network.

As discussed above, each content server 1021 and 1022 may be a content sharing application server (CSAS), an RSS web-site or a combination thereof. However, as discussed above, for the sake of brevity, content server 1021 will be discussed as a CSAS and content server 1022 will be discussed as an RSS web-site.

CSAS 1021 provides storage for personal content sharing. In one example, CSAS 1021 may be an enhanced web server with RSS support, and may provide web services and generate RSS feeds for stored content. With the assistance of the RSS gateway 106, summaries of content posted, published or shared by, for example, IMS client device 1001 may be pushed (e.g., sent unsolicited) from the CSAS 1021 to any other IMS client device successfully subscribed to the content sharing repository associated with IMS client device 1001. With the assistance of the RSS gateway 106, the CSAS 1021 may also control access to the shared content posted by IMS client device 1001.

Because example embodiments may use mobile blogging technology for content sharing, the CSAS 1021 may be referred to as a blog server. The CSAS 1021 may provide web blog service for each subscribing IMS client device and may store contents shared by an IMS client device in the content sharing application system. To share new content, IMS client devices may store the content into a content sharing repository by publishing a new post to the CSAS 1021. The CSAS 1021 may then generate an RSS feed and announce the feed to the RSS gateway 106. The CSAS 1021 may include a BLOG-API component 10211 supporting BLOG-API.

The BLOG-API component 10211 may allow, for example, IMS client device 1001 to update a content sharing repository within the CSAS 1021. The CSAS 1021 may also include a web module 10212 providing a web interface allowing IMS client device 1001 to update its content sharing repository through the Internet.

The CSAS 1021 may also include an interface allowing IMS client device 1001 to access and open a mobile content sharing service. Service providers may use this interface to create mappings between an IMS SIP ID and the base HTTP URL of the CSAS 1021. Combining the base HTTP URL and IMS SIP ID, the CSAS 1021 may locate the content repository of a particular IMS client device upon request.

As discussed above, example embodiments may allow IMS client device 1001 to control access to its content stored in the CSAS 1021. To do so, the CSAS 1021 may utilize an access control procedure as will be described in more detail below.

IMS client devices in a 3GPP-IMS network may be identified by the above-described SIP ID. One example of an SIP ID is “sip:mobile_number@service_provider.com”. As discussed above, the SIP ID may be used for IMS calls and/or presence subscription. IMS SIP IDs and uses for them are well-known in the art, and therefore, a detailed discussion will be omitted for the sake of brevity. Hereinafter, SIP ID will be abbreviated as S-ID.

When IMS client device 1001 subscribes to a multimedia content sharing service, the CSAS 1021 may allocate a new account ID to the IMS client device 1001. Methods for allocating account IDs at IMS content servers such as CSAS 1021 are well-known in the art, and as such, a detailed discussion will be omitted for the sake of brevity. Hereinafter, this account ID will be referred to as a C-ID.

Referring again to FIG. 2, the IMS client device 1001 may be in two-way communication with the CSAS 1021. This may enable the IMS client device 1001 to subscribe to multimedia content by communicating directly with the CSAS 1021. In this example, when IMS client device 1001 accesses CSAS 1021, a mapping between the mobile user's S-ID and C-ID may be created on the CSAS 1021 and the base HTTP URL of the CSAS 1021 may be stored in the profile for IMS client device 1001 at the HSS.

In another example, IMS client device 1001 may access multimedia content using the buddy list stored in IMS client device 1001. In this example, to access multimedia content provided by IMS client device 1002, which is in the buddy list of IMS client device 1001, IMS client device 1001 sends out multiple (e.g., two) SIP SUBSCRIBE messages. A first SIP SUBSCRIBE message may be sent to the presence server 112 with the S-ID1002 to obtain presence information associated with the IMS client device 1002, and a second SIP SUBSCRIBE message may be sent to APB 108 which forwards the message to RSS gateway 106 with the following SIP URI, “sip:blog=S-ID1002@rss_gw.service_provider.com”, for a content sharing update.

Upon receiving the content sharing update subscription, the RSS gateway 106 searches for the base HTTP URL of the CSAS 1021 in the HSS and locates the HTTP URL of the content repository for IMS client device 1002 using S-ID1002. If IMS client device 1002 has shared content available for IMS client device 1001, a 2xx response to the RSS content sharing request is sent. The RSS gateway 106 then uses the S-ID1001 within the response as the identifier to check the permission list of the requesting RSS feeds and retrieves RSS feeds using the determined HTTP URL.

In another example, when IMS client device 1001 shares content to other IMS clients, the IMS client device 1001 may control access per “post” or per “category”. The IMS client device 1001 may publish a post into a specific category and assign a permission list for the category. Only IMS client devices in the permission list may obtain the content summary of this post. In the permission list, each IMS client device may be represented by a corresponding S-ID. In this example, a static permission list may be associated with the category.

In yet another example, the IMS client device 1001 may publish a post which is only shared among a group of IMS client devices selected dynamically by IMS client device 1001, for example, through the use of the phone book for IMS client device 1001. In at least one example embodiment, the dynamic permission list may be selected by a user through the buddy list stored on the IMS client device 1001. For example, when IMS client device 1001 maintains his sharing content on the CSAS 1021, the IMS client device 1001 may divide the contents into categories and assign a permission list to each category to control access to particular content. BLOG-API may be enhanced to allow IMS client device 1001 to create a new permission list (e.g., static or dynamic) modify and/or delete an existing static permission list. The permission list may be stored on the CSAS 1021, and IMS client device 1001 may not maintain a permanent copy of the permission list. IMS client device 1001 may obtain the static permission list from the CSAS 1021 through the BLOG-API. When IMS client device 1001 publishes a post, IMS client device 1001 may associate the post with a permission list. If the permission list is created dynamically, the permission list may be published to the CSAS 1021 at the same time. This may enable access control of different granularities.

The permission list on the CSAS 1021 may be identified by a permission list ID. When the CSAS 1021 generates RSS feeds for shared content, the ID of the associated permission list may also be attached. When the RSS gateway 106 obtains or fetches RSS feeds from the CSAS 1021, the RSS gateway 106 may check whether a local copy of the permission list associated with the RSS feed is present within the RSS gateway 106. If not, the RSS gateway 106 obtains the permission list from the CSAS 1021. Then the RSS gateway 106 delivers the RSS feeds to subscribers in the permission list.

The permission list for a content repository associated with IMS client device 1001 may be updated by IMS client device 1001 using the APB client or the Internet. The RSS gateway 106 may keep the stored local copy synchronized with the actual permission list at the CSAS 1021. To keep the local copy synchronized, a timestamp may be assigned to the permission list. In each RSS feed, both the permission list ID and the timestamp may be embedded. When the RSS gateway 106 obtains an RSS feed and the timestamp of the permission list ID is newer (more recent) than the local copy, the RSS gateway 106 may obtain or fetch the updated permission list from the CSAS 1021.

The CSAS 1021 may also maintain a table for the permission list. The table may include at least four columns including the content owner, which is also the owner of the permission list, ID of the permission list, timestamp of the permission list, and the authorized subscribers. The owner and the authorized subscriber may be represented by their respective S-IDs. This table may be used by CSAS 1021 for the storage of the permission list. This table may be updated by IMS client devices owning the particular content and permission list as desired. The CSAS 1021 may provide a WEB GUI for users to update its permission list, and may provide an interface for RSS gateway 106 to access this table.

The RSS gateway 106 may also maintain a table for the permission list. This may be a duplication of the table on the CSAS 1021. This table may be used by RSS gateway 106 to determine to whom the RSS feeds should be delivered. When a change occurs in the permission list table on the CSAS 1021, the change will be reflected by the timestamp of the permission list ID. The RSS gateway 106 may detect the change from the fetched RSS feeds. Then the RSS gateway 106 may request the modified permission list and update its database.

As noted above, the content server 1022 may be an RSS web-site. RSS web-site 1022 provides news, weather forecasts, BBS articles, etc., and may generate content summaries in the form of RSS feeds. The RSS feeds generated by the RSS web-site 1022 may be provided to the RSS gateway 106, and may be viewed by IMS clients as “rich presence information.” Rich presence information is well-known in the art, and thus, a detailed discussion will be omitted for the sake of brevity. In the case of RSS web-site 1022, for distributing RSS feeds, RSS web-site 1022 may use another type of SIP URI, for example, “sip:channel=http_url@rss_gw.service_provider.com”. The http_url part identifies the RSS feeds at the RSS web-site 1022 and may be omitted when used in this way, as described in Berners-Lee, T. et al. “Uniform Resource Identifiers (URI): Generic Syntax”, RFC 2396, August 1998, the entire contents of which are incorporated herein by reference. This enables IMS client devices to use the content sharing system to obtain RSS feeds from any source. The RSS gateway 106 may extract the HTTP URL from the SUBSCRIBE request and fetch RSS feeds for the subscriber, as is well-known in the art.

In order to keep up-to-date RSS feeds available at the RSS gateway 106 and to keep IMS client devices updated with current RSS feeds, the IMS client devices, RSS gateway 106 and content servers 1021 and 1022 may synchronize RSS feeds. An example embodiment of this RSS feed synchronization will be discussed in more detail below with regard to IMS client device 1001, RSS gateway 106 and CSAS 1021. However, the same synchronization procedures will be described with regard to other IMS client devices and content servers.

For example, a delta change based method may be used for the interface between the RSS gateway 106 and CSAS 102. This method is well-known in the art, and will only be discussed briefly herein for the sake of brevity. In at least one example embodiment, when the RSS gateway 106 fetches RSS feeds using HTTP protocol, an “If-Modified-Since” header may be added in the request. The value of the “If-Modified-Since” header may be the publication date PubDate of the latest feed that has been fetched. A “Last-Modified” header may also be included in the response. The RSS gateway 106 may fetch RSS feeds from RSS-enabled content servers periodically.

Similarly, a delta change based method may also be used for the interface between client device 1001 and the RSS gateway 106. For example, when client device 1001 subscribes to RSS feeds, an “If-Modified-Since” header may be included in the subscribe filter. Then the RSS gateway 106 may notify IMS client device 1001 with only feeds newer than the current value of this header. In this example, IMS client device 1001 may retain a local cache of RSS feeds. An RSS feed may be relatively small such that it is feasible for IMS client device 1001 to maintain such a cache. The local cache may save transmission bandwidth because RSS feeds need not be requested each time IMS client device 1001 starts or is powered on.

A subscribe filter may also include an off-peak downloading policy. In this example, the RSS gateway 106 may select an appropriate time to send the NOTIFY to clients according to the subscribe filter. These policies may be written to the configuration file of each client and be added to the SUBSCRIBE request by the APB server 108.

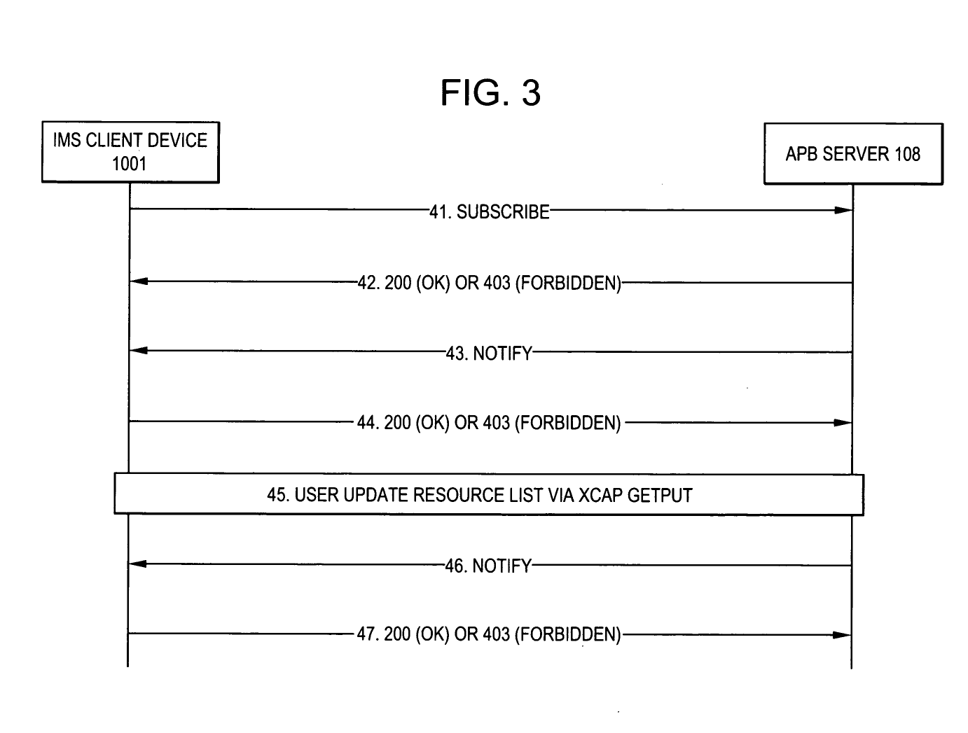

FIG. 3 illustrates a message flow diagram for RSS subscription management, according to an example embodiment. That is, for example, FIG. 3 illustrates an example message flow between subscribing IMS client 1001 and the APB server 108 for subscribing to one or more RSS feeds. This message flow is also illustrated in section A.3.6 of 3GPP TS 24.141, which is incorporated herein by reference.

Referring to FIG. 3, when IMS client device 1001 wishes to receive notification when its resource list is modified via XCAP, the IMS client device 1001 generates and sends a SUBSCRIBE request (at 41) indicating support for “sip-profile”, together with an indication of the length of time this periodic subscription should last to initiate a subscription to XCAP document changes in APB server 108.

The APB server 108 performs the necessary authorization checks on the originator to ensure that the IMS client device 1001 is authorized to subscribe to XML document changes. If this condition is met, the APB server 108 sends a 200 (OK) response back to the IMS client device 1002 (at 42). Otherwise, the APB server 108 returns a 403 (Forbidden) response (at 42).

After sending the 200 (OK) response, the APB server 108 generates and sends a NOTIFY message (at 43) including the XCAP document including a resource list to the subscribing client device 1001.

If properly received, the IMS client device 1001 acknowledges the NOTIFY message with a 200 (OK) response (at 44). Otherwise, the IMS client device 1001 returns a 403 forbidden response (at 44). The IMS client device 1001 receives a copy of the resource list (e.g., an RSS channel subscription) and updates the resource list using XCAP protocol (at 45), and sends the updated resource list back to the APB server 108. The detailed message flow of the updating of the resource list is illustrated in section A.8 of 3GPP TS 24.141, the entire contents of which are incorporated herein by reference.

If the IMS client device 1001 updates the resource list, the APB server 108 sends a NOTIFY message (at 46) to the IMS client device 1001 indicating the change. If properly received, the IMS client device 1001 acknowledges the NOTIFY message with a 200 (OK) response (at 47). Otherwise, the IMS client device 1001 returns a 403 forbidden response (at 47).

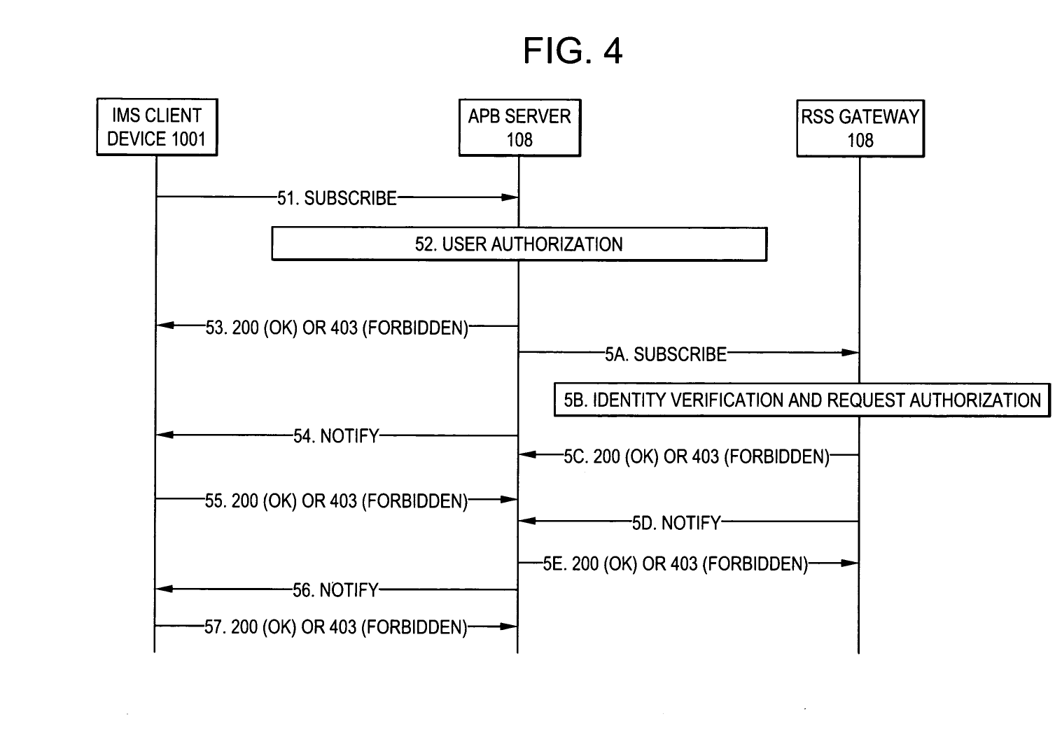

FIG. 4 illustrates a message flow diagram for a subscription message flow, according to an example embodiment. This message flow is illustrated in Annex A of 3GPP TS 24.141, the contents of which are incorporated herein by reference. The message flow diagram of FIG. 4 will be described with regard to subscribing IMS client device 1001.

Referring to FIG. 4, when IMS client device 1001 wishes to receive RSS feeds from a list of RSS channels, the IMS client device 1001 generates and sends a SUBSCRIBE request (at 51) to the APB server 108 to initiate a subscription. The APB server 108 performs the necessary authorization checks (at 52) on the IMS client device 1001 to ensure that the IMS client device 1002 is authorized to access the resource list. For example, when the APB server 108 receives a SUBSCRIBE request, the APB server 108 attempts to verify the identity of the source of the SUBSCRIBE request as described in 3GPP TS 24.229 sub clause 5.7.1.4, the contents of which are incorporated herein by reference, then performs authorization according to 3GPP TS 24.229 sub clause 5.7.1.5, the entire contents of which are incorporated herein by reference.

If the authorization check passes, the APB server 108 sends a 200 (OK) response to the IMS client device 1001 (at 53). Otherwise, if the previous condition failed, then a 403 (Forbidden) response is sent to the IMS client device 1001. The APB server 108 resolves the resource address associated with IMS client device 1001 and subscribes to RSS channels listed in the resource list SIP URI by sending an SUBSCRIBE request to the RSS gateway 106 (at 5A). The APB server 108 also generates and sends an immediate NOTIFY message (at 54) to the IMS client device 1001 in response to the received SUBSCRIBE request. The body of the NOTIFY message may or may not contain RSS feeds depending on whether the APB server 108 has the RSS feeds the IMS client device 1001 has requested.

If properly received, the IMS client device 1001 acknowledges the NOTIFY message with a 200 (OK) response (at 55). Otherwise, the IMS client device returns a 403 forbidden response (at 55). When APB server 108 receives updated RSS feeds, the APB server 108 may generate and send additional NOTIFY messages to the IMS client device 1001 (at 56), and if properly received, the IMS client device 1001 acknowledges the NOTIFY message with a 200 (OK) response (at 57). Otherwise, the IMS client device 1001 returns a 403 forbidden response (at 55).

Still referring to FIG. 4, after receiving the SUBSCRIBE request from the APB server 108, RSS gateway 106 performs the necessary authorization checks on the IMS client device 1001 to ensure that IMS client device 1001 is authorized to access the shared content (at 5B). For example, in response to the SUBSCRIBE request, the RSS gateway 106 attempts to verify the identity of IMS client device 1001 as described in 3GPP TS 24.229 sub clause 5.7.1.4, then performs an authorization check according to 3GPP TS 24.229 sub clause 5.7.1.5, the contents of which are incorporated herein by reference. The identity verification is an optional check for RSS gateway 106 because CSCFs in the IMS core network may have already done the identity verification.

If the authorization check passes (at 5B), the RSS gateway 106 sends a 200 (OK) response to the APB server 108 (at 5C). If the previous condition failed, then a 403 (Forbidden) response is sent to the APB server 108 (at 5C). When the RSS gateway 106 sends a 200 (OK) response to accept the subscription, the RSS gateway 106 sends a NOTIFY message with the current RSS feeds of the RSS channel that the IMS client device 1001 has subscribed and been authorized to access (at 5D). If properly received, the APB server 108 acknowledges the NOTIFY message with a 200 (OK) response (at 5E). Otherwise, the APB server 108 returns a 403 forbidden response (at 5E).

Still referring to FIG. 4, in at least one example embodiment, one or more IMS client devices may subscribe to desired information at both APB server 108 and an RSS gateway 106, and the RSS gateway 106 may aggregate subscription requests from IMS client devices before subscribing to requested multimedia content at, for example, CSAS 1021 and/or RSS web-site 1022. That is, for example, the RSS gateway 106 may aggregate subscription requests from a plurality of IMS client devices and then subscribe to the requested RSS feeds on their behalf. The RSS gateway 106 may also receive RSS feeds over HTTP from the CSAS 1021 and RSS web-site 1022 and sends the received RSS feeds to subscribing IMS client devices using, for example, SIP, WAP Push, etc. In this example embodiment, subscribing IMS client devices may only receive notifications regarding desired content.

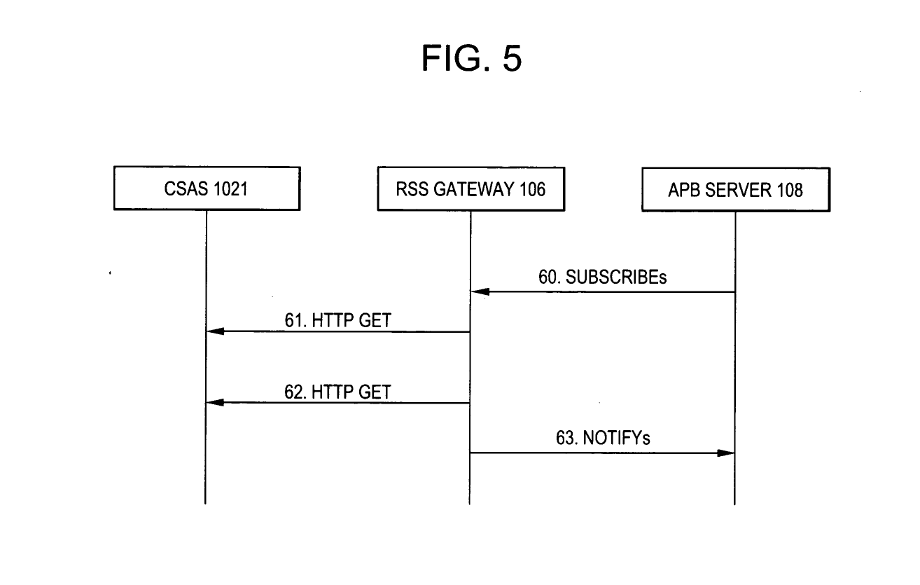

FIG. 5 illustrates a message flow diagram showing a message flow between the APB server 108, RSS gateway 106 and a content server, according to an example embodiment. The message flow diagram of FIG. 5 will be described with regard to CSAS 1021; however, a similar message flow diagram applies to the RSS web-site 1022. Moreover, although the message flow diagram of FIG. 5 will be described with regard to the APB server 108, it will be understood that IMS clients may transmit similar messages directly to the RSS gateway 106.

Referring to FIG. 5, when IMS client device 1001 wishes to retrieve RSS feeds from a RSS channel, the APB server 108 generates and sends a SUBSCRIBE request to the RSS gateway 106 on behalf of the IMS client device 1001 (at 60). The RSS gateway 106 sends a 200 (OK) response to the APB server 108 to accept the subscription (not shown). Otherwise, the RSS gateway 106 returns a 403 forbidden response.

The RSS gateway 106 may then locate the CSAS 1021 hosting the content requested by IMS client device 1001. If access to requested content is controlled, the RSS gateway 106 may implement an access control procedure, which may be the same as the above-described access control procedure. If an access request is granted. Upon accepting the subscription from APB server 108, RSS gateway 106 fetches the requested RSS feeds (at 61) from the CSAS 1021 if there is no local cache of the requested feeds stored at the RSS gateway 106. In one example, the HTTP URL may be deduced from the request URI of the SUBSCRIBE request, and the RSS gateway 106 may retrieve the RSS feeds using the HTTP protocol. The RSS feeds fetched are cached in the local database at the RSS gateway 106. In at least one example embodiment, the RSS gateway 106 may fetch a plurality of feeds from one or more content servers simultaneously, and aggregate the obtained RSS feeds.

Referring still to FIG. 5, if the fetched RSS feeds contain a permission list ID, which is not found or is newer than the one in the local database at the RSS gateway 106, the RSS gateway 106 sends another HTTP request to the CSAS 1021 (at 62) to fetch the permission list related to the ID. This new permission list is saved in the local database at the RSS gateway 106.

After initially fetching RSS feeds, the RSS gateway 106 fetches RSS feeds from the designated content server, for example, periodically. When a new RSS feed is obtained, the RSS gateway 106 pushes the new RSS feed to IMS client devices subscribing to the related RSS channel. RSS feeds are a special type of the well-known “presence” information. According to example embodiments, RSS feeds may be updated according to the time of receipt. RSS feeds may be similar to well-known presence information, however, the current status for a particular RSS feed may be different for different subscribing IMS client devices.

When new feeds are obtained from CSAS 1021, the RSS gateway 106 may search for the subscribing IMS client devices in the subscription table and check for the subscribing IMS client devices in the permission in the permission list table. If the subscribing IMS client device is in the permission list, the permission check passes, and the RSS gateway 106 notifies the subscribing IMS client device of the new event. The refreshing of the feed item table may be a local policy set by the RSS gateway 106 according to the RSS channel and pubDate.

Referring back to FIG. 5, for example, when new RSS feeds are obtained from the CSAS 1021, the RSS gateway 106 generates and sends a NOTIFY message (at 63) if the IMS client device 1001 is on the permission list associated with the RSS feed. The requested RSS feeds may be embedded in the body of the NOTIFY messages. Some SIP messages, such as 2000K responses to the NOTIFY messages, are well-known in the art, and therefore, have been omitted for the sake of brevity.

According to example embodiments of the present invention, because no specific SIP extensions are added to IMS core network elements (e.g., CSCFs, HSS and presence servers), the content sharing application system, according to example embodiments, may be deployed on top of any IMS compatible infrastructure.

The invention being thus described, it will be obvious that the same may be varied in many ways. Such variations are not to be regarded as a departure from the invention, and all such modifications are intended to be included within the scope of the invention.

We claim:

1. A method for subscribing to multimedia content for a plurality of users, the method comprising:
receiving at least one subscription request for multimedia content from at least one of the plurality of users, the at least one of the plurality of users being a mobile user;
aggregating the received subscription requests to produce an aggregate subscription request; and
subscribing to multimedia content based on the aggregate subscription request.

2. The method of claim 1, wherein the subscription request is received in a session initiation protocol message.

3. The method of claim 1, further comprising:
receiving a first summary of the requested multimedia content in response to the subscribing step; and
providing the first summary of requested multimedia content to the at least one of the plurality of users after receiving the first summary.

4. The method of claim 3, wherein the summary of the requested multimedia content is provided in a session initiation protocol message.

5. The method of claim 3, further comprising:
receiving an updated summary of the multimedia content after receiving the first summary; and
providing the updated summary to the at least one of the plurality of users after receiving the updated summary without a further subscription request.

6. The method of claim 1, further comprising:
determining if the at least one of the plurality of users is authorized to subscribe to the multimedia content; and wherein
the aggregating step aggregates received subscription requests from each of the at least one users authorized to subscribed to the multimedia content.

7. The method of claim 1, wherein the at least one of the plurality of users is authorized to subscribe to the multimedia content if an SIP-ID associated with the one of the plurality of users is present in a permission list.

8. A method for providing multimedia content from a plurality of users, the method comprising:
receiving a summary of shared multimedia content from at least one content server;
generating a message summarizing the received multimedia content; and
providing the message summarizing the received multimedia content to at least one of the plurality of users in response to a subscription request, the at least one user being a mobile user.

9. The method of claim 8, further comprising:
storing the received summary in a database; and
providing the message summarizing the received multimedia content to at least one other of the plurality of users in response to a subscription request from the at least one other of the plurality of users.

10. The method of claim 8, wherein the message summarizing the received multimedia content is a Really Simple Syndication feed.

11. The method of claim 8, wherein the message summarizing the received multimedia content is provided in a session initiation protocol message.

12. The method of claim 8, wherein the shared multimedia content is multimedia content posted at a web-site.

13. The method of claim 8, further comprising:
receiving an updated summary of the shared multimedia content; and
providing the updated summary to the at least one of the plurality of users after receiving the updated summary without receiving a further subscription request.

14. The method of claim 8, further comprising:
determining if the at least one of the plurality of users is authorized to receive a summary of the shared multimedia content; and wherein
the providing step provides the message summarizing the received multimedia content to the at least one of the plurality of users if the determining step determines that the at least one of the plurality of users is authorized to receive the summary.

15. A method for receiving shared multimedia content, the method comprising:
subscribing to multimedia content stored at a server by transmitting a subscription request message to a gateway storing a summary of the multimedia content located at the server, at least a portion of the multimedia content stored at the server being provided by a mobile user via a wireless network; and
receiving a summary of the multimedia content from the gateway via the wireless network.

16. The method of claim 15, wherein the subscription request is transmitted in a session initiation protocol message.

17. The method of claim 15, wherein the summary of the requested multimedia content is a Really Simple Syndication feed.

18. The method of claim 15, wherein the summary of the requested multimedia content is received in a session initiation protocol message.

19. The method of claim 15, further comprising:
accessing the multimedia content in response to the received summary of the multimedia content, the accessing being via the wireless network.
